(19) United States
(12) Patent Application Publication
(10) Pub. No.: US 2026/0059167 A1
(43) Pub. Date: Feb. 26, 2026

(54) METHODS AND APPARATUS FOR PROVIDING AND UPLOADING CONTENT TO PERSONALIZED NETWORK STORAGE

(71) Applicant: Time Warner Cable Enterprises LLC, St. Louis, MO (US)

(72) Inventor: Michael L. LaJoie, Stamford, CT (US)

(21) Appl. No.: 19/268,424

(22) Filed: Jul. 14, 2025

Related U.S. Application Data
(62) Division of application No. 17/385,710, filed on Jul. 26, 2021, now Pat. No. 12,363,383.
Application No. 17/385,710 is a continuation of application No. 15/969,597, filed on May 2, 2018, now Pat. No. 11,076,203.
Application No. 15/969,597 is a division of application No. 13/797,577, filed on Mar. 12, 2013, now abandoned.

(51) Int. Cl. H04N 21/4627; G06F 21/10; H04L 9/40; H04N 21/2743; H04N 21/44; H04N 21/443

(52) U.S. Cl. CPC H04N 21/4627; G06F 21/10; H04L 63/0428; H04N 21/2743; H04N 21/44; H04N 21/4432

(57) ABSTRACT

Methods and apparatus for delivering, uploading, and storing content for users of a network so that the user has “virtual” ownership of and access to the content, thereby obviating the need for additional storage space at the client premises and offering seamless compliance with copyright laws. In an exemplary embodiment, the network comprises a hybrid fiber coax (HFC) network, and sessions are used to deliver content to the requesting owner and then back to storage space associated with the head-end where the content remains available for future subscriber requests. Various other complementary features for enhancing the user's virtual ownership experience are also disclosed.

### RELATED APPLICATIONS

This application is related to commonly owned U.S. patent application Ser. No. 11/440,490 filed May 24, 2006 and entitled “PERSONAL CONTENT SERVER APPARATUS AND METHODS”, and U.S. patent application Ser. No. 11/811,953 filed Jun. 11, 2007 entitled “METHODS AND APPARATUS FOR PROVIDING VIRTUAL CONTENT OVER A NETWORK”, each of the foregoing incorporated herein by reference in its entirety.

### BACKGROUND

### 1. Technological Field

The present disclosure relates generally to the field of providing content over a network and other distribution channels, and specifically in one aspect to the configuration, delivery, upload, and storage of such content over a managed network such as e.g., cable television network.

### 2. Description of Related Technology

Recent advances in video capture and data storage technologies have led to the proliferation of consumer electronics devices that allow a user to record video programming or other content received from a bearer network (such as a cable television or satellite network) on a digital video recorder (DVR) or personal video recorder (PVR), and contemporaneously or subsequently access the content. The advent of PVR technology has greatly increased the ability of a subscriber to utilize certain content delivered over their cable system on their schedule. Some PVR devices can be used to transmit the stored content over a network interface to another device (which may or may not be remote from the PVR) where the same or another user can access the content. As a result, PVRs allow users a great degree of control over the playback and viewing of their selected content.

Additionally, network-based content recording and storage allow users of a network to obtain what would otherwise be “live” content (e.g., linear television broadcasts or the like) at a time convenient to the user. These systems typically receive instructions from the user as to which programming they want to view, and the network “cloud” streams the requested content to that user. Variants of these types of systems either receive prior instructions from a user before the broadcast of the live event, or alternatively store various content based on some other criteria (e.g., popularity), and then allow the user a period of time to watch it.

However, content source or copyright owner must have assurances that the network operator (e.g., multiple systems operator or MSO) which is entrusted with their valuable content will process and distribute this content within the limitations of the law, and not expose the content to undue risk of unauthorized reproduction or distribution. Content owners may be concerned with the reproduction of copies of their content within the network for distribution purposes. For example, a network operator may have restrictions on replicating and/or distributing content received from the content source. Certain activities are generally recognized as not being in violation of a content owner's copyright. For example, so called “time shifting” (i.e., recording or storing the content for later viewing), and “space shifting” (i.e., moving content from one device or medium to another) of content owned by a purchaser in certain circumstances are recognized by U.S. courts as not violating copyrights. However, the application of such rules is typically quite fact-specific, such as in the case of networked PVRs (NPVRs).

Network operators that provide users with personalized PVR functionality and storage in the network can simplify the distribution and upgrade process of their services, and offer potentially unlimited storage capacity, without sacrificing ease of use or convenience at the user end. However, current PVR and NPVR implementations avoid uploading content to network storage when the content has already been received at a PVR or NPVR, due in part to restrictions associated with upload bandwidth, thereby potentially leaving some copyright concerns unaddressed.

Accordingly, there is a need for improved methods and apparatus which effectively balances the preservation of copyright interests with the convenience and flexibility of PVR and NPVR functionality.

These methods and apparatus would also, in one embodiment, be provided using substantially extant network infrastructure and components, and would be compatible with a number of different client device and delivery systems, including both wired and wireless technologies.

### SUMMARY

The foregoing needs are satisfied by providing improved apparatus and methods for content management and device configuration for uploading and storing content over a content network.

In a first aspect, a method of content management is disclosed. In one embodiment, the method is utilized within a content delivery network having a plurality of users, and the method includes receiving content at a client device, the client device associated with at least one of the plurality of users of the network; and in response to the act of receiving, causing at least a portion of the content to be uploaded to a storage entity of the network. In one variant, the storage entity is configured to store the content at a storage location specifically associated with at least the at least one user.

In another aspect, a network apparatus configured to obtain and store content from one or more client devices is disclosed. In one embodiment, the apparatus includes: a storage apparatus; and a digital processor configured to run at least one computer program thereon, the computer program comprising a plurality of instructions. In one variant, the instructions are configured to, when executed, cause the network apparatus to: configure at least one of the one or more client devices for upload; receive a request from at least one of the one or more client devices for the content; determine whether the requested content has previously been uploaded to a storage location specifically associated with the one or more client devices; and based at least in part on the determination, provide the requested content to the at least one of the one or more client devices.

In another aspect, a method of managing content via a content delivery network, so as to ensure copyright preservation is disclosed. In one embodiment, the method includes: recording a first content element on a recording device at a first location, the recording device being associated with a first user; automatically uploading the first content element to a second device at a second location, the second location being in communication with the first location via the content delivery network, the first content element being made accessible only to the first user so as to protect a copyright associated with the first content element.

In a further aspect, a consumer premises device is disclosed. In one embodiment, the device includes computerized logic configured to cause download of content from a network entity to the device (or a proxy thereof), and also upload of the content back to the same or different network entity, the receiving network entity having one or more access restrictions associated therewith.

In yet another aspect, a computer readable apparatus is disclosed. In one embodiment, the apparatus includes a storage medium and at least one computer program disposed thereon, the at least one program configured to, when executed, implement content copyright protection upload functionality.

### BRIEF DESCRIPTION OF THE DRAWINGS

FIG. 1 is a functional block diagram illustrating an exemplary hybrid fiber coax (HFC) cable network configuration useful with various aspects of the present disclosure.

Fig. 1a is a functional block diagram illustrating one exemplary HFC cable network head-end configuration useful with various aspects of the present disclosure.

FIG. 1b is a functional block diagram illustrating one exemplary local service node configuration useful with various aspects of the present disclosure.

FIG. 1c is a functional block diagram illustrating one exemplary broadcast switched architecture (BSA) useful with various aspects of the present disclosure.

FIG. 1d is a functional block diagram illustrating one exemplary packetized content delivery network architecture useful with the present disclosure.

FIG. 2 is a functional block diagram of one exemplary embodiment of the system architecture according to the disclosure.

FIG. 3 is a functional block diagram of one exemplary embodiment of a network server apparatus adapted for use with the system architecture of FIG. 2.

FIG. 4 is a functional block diagram of one exemplary embodiment of consumer premises equipment (CPE) adapted for use with the system architecture.

FIG. 5 is a logical flowchart illustrating one embodiment of the generalized content delivery, upload and storage methodology of the disclosure.

### DETAILED DESCRIPTION

Reference is now made to the drawings wherein like numerals refer to like parts throughout.

As used herein, the term “application” refers generally and without limitation to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could comprise a downloadable Java Xlet™ that runs within the JavaTV™ environment.

As used herein the term “browser” refers to any computer program, application or module which provides network access capability including, without limitation, Internet browsers adapted for accessing one or more websites or URLs over the Internet, as well as any “user agent”including those adapted for visual, aural, or tactile communications.

As used herein, the terms “client device” and “end user device” include, but are not limited to, set-top boxes (e.g., DSTBs), digital television sets, personal computers (PCs), and minicomputers, whether desktop, laptop, or otherwise, and mobile devices such as handheld computers, PDAs, personal media devices (PMDs), such as for example an iPod™M or Motorola ROKR, and smartphones.

As used herein, the term “codec” refers to an video, audio, or other data coding and/or decoding algorithm, process or apparatus including, without limitation, those of the MPEG (e.g., MPEG-1, MPEG-2, MPEG-4, etc.), Real (RealVideo, etc.), AVC/H.264, AC-3 (audio), DIVX, XVID/ViDX, Windows Media Video (e.g., WMV 7, 8, or 9), ATI Video codec, or VC-1 (SMPTE standard 421M) families.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “conditional access” refers to any access control scheme, whether implemented in hardware, software, or firmware (or combinations thereof), including without limitation members of the “Powerkey” family (Powerkey Book 2, Powerkey Book 3, etc.), NDS (including VideoGuard, m VideoGuard, etc.), ANSI/SCTE Standard 52 2003 (DVS-042), incorporated herein by reference in its entirety, and Motorola/General Instrument DigiCipher® family (DigiCipher II, etc.). These can be implemented using, for example, the so-called “CableCard” plug-in security module access technology, a downloadable CA system (DCAS), or otherwise.

The terms “Customer Premises Equipment (CPE)” and “host device” refer without limitation to any type of electronic equipment located within a customer's or user's premises and connected to a network. The term “host device” refers generally to a terminal device that has access to digital television content via a satellite, cable, or terrestrial network. The host device functionality may be integrated into a digital television (DTV) set. The term “customer premises equipment” (CPE) includes such electronic equipment such as set-top boxes (e.g., DSTBs), televisions, cable modems (CMs), embedded multimedia terminal adapters (eMTAs), whether stand-alone or integrated with other devices, Digital Video Recorders (DVR), gateway storage devices (Furnace), and ITV Personal Computers.

As used herein, the term “database” refers generally to one or more tangible or virtual data storage locations, which may or may not be physically co-located with each other or other system components.

As used herein, the term “display” means any type of device adapted to display information, including without limitation CRTs, LCDs, TFTs, plasma displays, LEDs, incandescent and fluorescent devices. Display devices may also include less dynamic devices such as, for example, printers, e-ink devices, and the like.

As used herein, the term “DVR” (digital video recorder) refers generally to any type or recording mechanism and/or software environment or function whereby content sent over a network can be recorded and selectively recalled, including without limitation so-called “personal video recording” (PVR) functions or devices. Such DVR may be dedicated in nature, or part of a non-dedicated or multi-function system.

As used herein, the term “DOCSIS” refers to any of the existing or planned variants of the Data Over Cable Services Interface Specification, including for example DOCSIS versions 1.0, 1.1, 2.0 and 3.0. DOCSIS (version 1.0) is a standard and protocol for internet access using a “digital” cable network. DOCSIS 1.1 is interoperable with DOCSIS 1.0, and has data rate and latency guarantees (VOIP), as well as improved security compared to DOCSIS 1.0. DOCSIS 2.0 is interoperable with 1.0 and 1.1, yet provides a wider upstream band (6.4 MHz), as well as new modulation formats including TDMA and CDMA. It also provides symmetric services (30 Mbps upstream).

As used herein, the term “head-end” refers generally to a networked system controlled by an operator (e.g., an MSO) that distributes programming to MSO clientele using client devices. Such programming may include any information source/receiver including, inter alia, free-to-air TV channels, pay TV channels, interactive TV, and the Internet. DSTBs may take on any configuration, and can be retail devices meaning that consumers may or may not obtain their DSTBs from the MSO exclusively. Accordingly, it is anticipated that MSO networks may have client devices from multiple vendors, and these client devices will have widely varying hardware capabilities. Multiple regional head-ends may be in the same or different cities.

As used herein, the term “integrated circuit (IC)” refers to any type of device having any level of integration (including without limitation ULSI, VLSI, and LSI) and irrespective of process or base materials (including, without limitation Si, SiGe, CMOS and GaAs). ICs may include, for example, memory devices (e.g., DRAM, SRAM, DDRAM, EEPROM/Flash, ROM), digital processors, SoC devices, FPGAs, ASICs, ADCs, DACs, transceivers, memory controllers, and other devices, as well as any combinations thereof.

As used herein, the terms “Internet” and “internet” are used interchangeably to refer to inter-networks including, without limitation, the Internet.

As used herein, the terms “local” and “remote” refer generally to devices, entities, or users that are serviced by substantially different communications channels. These terms are intended to be relative, and bear no physical or absolute reference or connotation as to the placement of the communication channels or the served device, entities or users. For example, a “local” network may comprise the MSO cable or satellite network, whereas a “remote” network may comprise the Internet or a LAN/WAN/MAN, the latter which may serve the very same premises.

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the terms “microprocessor” and “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the term “modem” refers to any kind of modulation or demodulation process or apparatus including without limitation cable (e.g., DOCSIS compliant) modems, DSL modems, analog modems, and so forth.

As used herein, the terms “MSO” or “multiple system operator” refer to a cable, satellite, or terrestrial network provider having infrastructure required to deliver services including programming and data over those mediums.

As used herein, the terms “network” and “bearer network” refer generally to any type of telecommunications or data network including, without limitation, hybrid fiber coax (HFC) networks, satellite networks, telco networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, TCP/IP, H.323, etc.).

As used herein, the term “network agent” refers to any network entity (whether software, firmware, and/or hardware based) adapted to perform one or more specific purposes. For example, a network agent may comprise a computer program running in server belonging to a network operator, which is in communication with one or more processes on a CPE or other device.

As used herein, the term “network interface” refers to any signal or data interface with a component or network including, without limitation, those of the Firewire (e.g., FW400, FW800, etc.), USB (e.g., USB2), Ethernet (e.g., 10/100, 10/100/1000 (Gigabit Ethernet), 10-Gig-E, etc.), MoCA, Serial ATA (e.g., SATA, e-SATA, SATAII), Ultra-ATA/DMA, Coaxsys (e.g., TVnet™), radio frequency tuner (e.g., in-band or OOB, cable modem, etc.), modem, WiFi (802.11a,b,g,n), WiMAX (802.16), PAN (802.15), or IrDA families.

As used herein, the term “purchase” shall mean without limitation any sale, agreement for sale, transfer of funds, promise to transfer funds, barter arrangement, promotional or incentive agreement or arrangement, virtual ownership, subscription, or other relationship wherein consideration of any kind is exchanged between two or more parties (or their proxies).

As used herein, the term “QAM” refers to modulation schemes used for sending signals over cable networks. Such modulation scheme might use any constellation level (e.g. QPSK, QAM-16, QAM-64, QAM-256 etc.) depending on details of a cable network. A QAM may also refer to a physical channel modulated according to said schemes.

As used herein, the term “recording medium” refers to any material, component, collection of components or device adapted to store information in a substantially permanent or semi-permanent state. Exemplars of recording media include, without limitation, magnetic media, integrated circuits (e.g., RAM or ROM), optical media, chemical media, and atomic-and subatomic-level storage structures (e.g., crystalline structures, quantum or spin states, etc.).

As used herein, the term “server” refers to any computerized component, system or entity regardless of form which is adapted to provide data, files, applications, content, or other services to one or more other devices or entities on a computer network.

As used herein, the term “user interface” refers to, without limitation, any visual, graphical, tactile, audible, sensory, or other means of providing information to and/or receiving information from a user or other entity. A user interface may comprise, for example, a computer screen display, touch screen, speech recognition engine, text-to-speech (TTS) algorithm, and so forth.

As used herein, the term “Wi-Fi” refers to, without limitation, any of the variants of IEEE-Std. 802.11 or related standards including 802.11 a/b/g/n/v.

As used herein, the term “wireless” means any wireless signal, data, communication, or other interface including without limitation Wi-Fi, Bluetooth, 3G, LTE/LTE-A, HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, analog cellular, CDPD, satellite systems, millimeter wave or microwave systems, acoustic, and infrared (i.e., IrDA).

### Overview

In one salient aspect, improved apparatus and methods are provided to, inter alia, enable upload and storage of content over a network. In one embodiment, content stored on a CPE is uploaded to server at the head-end, as opposed to traditional network DVR functionality which records content for subscribers at the head-end before it is received by the CPE. The improved apparatus and methods disclosed herein may be useful, for example, as one potential model for preserving the digital rights of content owners.

In an exemplary embodiment, a CPE and/or server at the network head-end is configured with logic to manage content delivery, upload and storage. A user receives content from a content source (which may be the network, or yet another source), and automatically uploads the content to a network storage device, where a complete copy of the content is made available for subsequent streaming/download to the user (or user devices that are allowed access to the network storage device).

In addition, the system determines which content items have already been uploaded/stored to the head-end so that an optimal number of copies are stored at the head-end and/or client device. Further, uploads may be prioritized in accordance with the copyright of individual content items.

### Detailed Description of Exemplary Embodiments

Exemplary embodiments of the apparatus and methods are now described in detail. While these exemplary embodiments are described in the context of the aforementioned hybrid fiber coax (HFC) cable architecture used in conjunction with e.g., a “secondary” communication channel or network, the general principles and advantages of the system may be extended to other types of networks and architectures where delivery of content is required or desirable, whether broadband, narrowband, wired or wireless, content or data, or otherwise, and irrespective of topology. Hence, the following description is merely exemplary in nature.

It will also be appreciated that while described generally in the context of a network providing service to a consumer (i.e., home) end user domain, the system may be readily adapted to other types of environments including, e.g., commercial/enterprise, and government/military applications. Myriad other applications are possible.

It is further noted that while aspects are described primarily in the context of 6 MHZ RF channels within the HFC network, any frequency/bandwidth, such as for example 8 MHZ channels may be applicable.

Furthermore, as referenced above, the system is in no way limited to traditional cable system frequencies (i.e., below 1 GHZ), and in fact may be used with systems that operate above 1 GHz band in center frequency or bandwidth, to include without limitation so-called ultra-wideband (UWB) systems. For example, in one variant, high-bandwidth UWB signals imposed atop the traditional QAMs of the cable network are used to provide a high-speed data download capability for the content to be utilized at the subscriber's premises (e.g., applications or archived data).

Also, while certain aspects are described primarily in the context of the well-known Internet Protocol (described in, inter alia, RFC 791 and 2460), it will be appreciated that other types of protocols (and in fact bearer networks to include other internets and intranets) may be used to implement the described functionality.

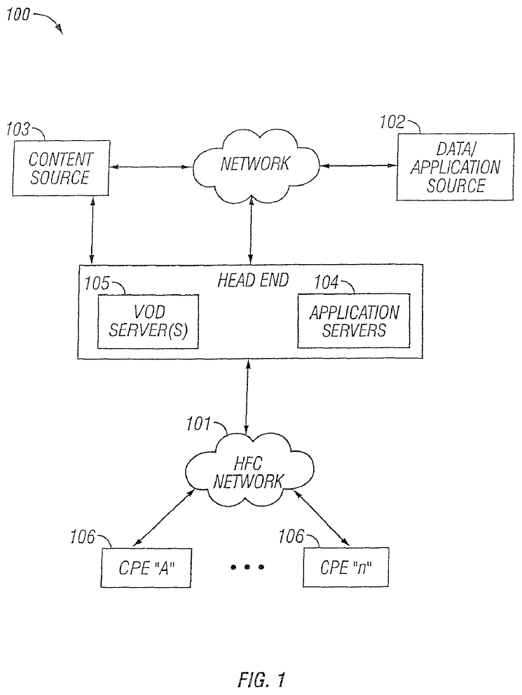

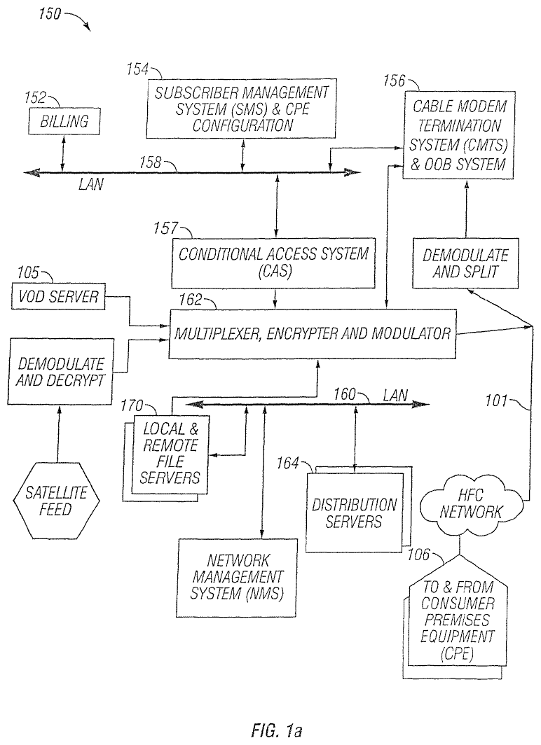

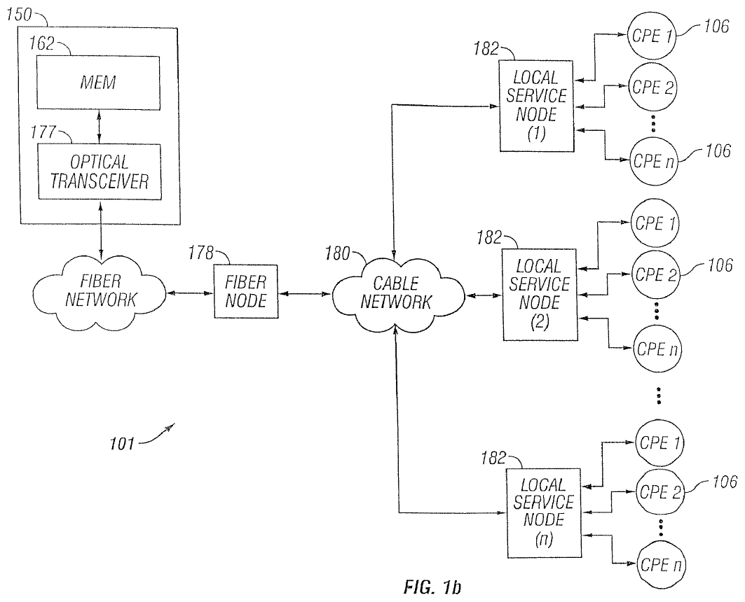

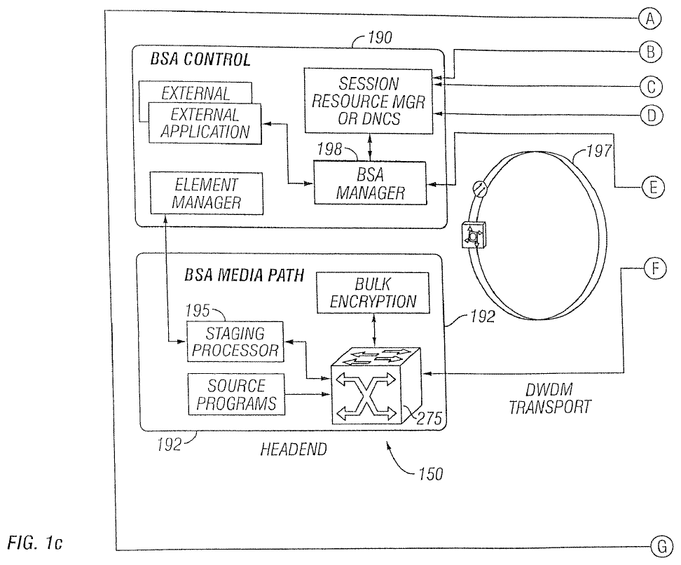

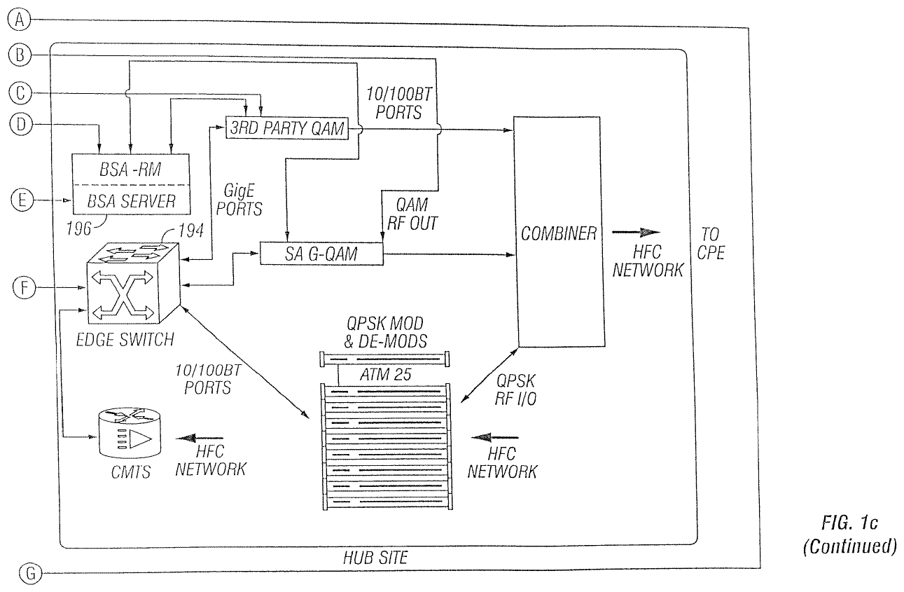

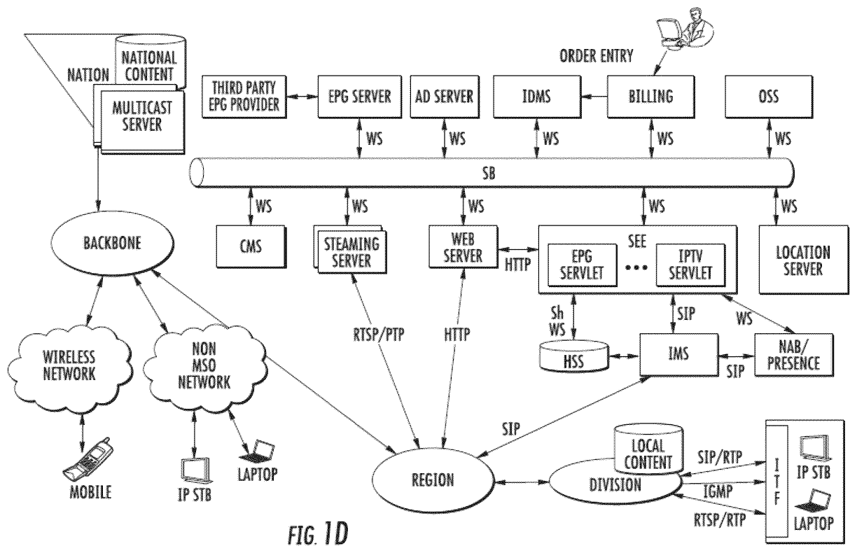

FIG. 1 illustrates a typical generalized content delivery network configuration with which the personal media delivery apparatus and methods may be used. The various components of the network 100 include (i) one or more data and application origination points 102; (ii) one or more content sources 103, (iii) one or more application distribution servers 104; (iv) one or more VOD servers 105, and (v) consumer premises equipment (CPE) 106. The distribution server(s) 104, VOD servers 105 and CPE(s) 106 are connected via a bearer (e.g., HFC) network 101. A simple architecture comprising one of each of the aforementioned components 102, 104, 105, 106 is shown in FIG. 1 for simplicity, although it will be recognized that comparable architectures with multiple origination points, distribution servers, VOD servers, and/or CPE devices (as well as different network topologies) may be utilized. For example, the head-end architecture of FIG. 1a (described in greater detail below) may be used.

The data/application origination point 102 comprises any medium that allows data and/or applications (such as a VOD-based application, gaming application, or “Watch TV” application) to be transferred to a distribution server 104. This can include for example a third party data source, application vendor website, CD-ROM, external network interface, mass storage device (e.g., RAID system), etc. Such transference may be automatic, initiated upon the occurrence of one or more specified events (such as the receipt of a request packet or ACK), performed manually, or accomplished in any number of other modes readily recognized by those of ordinary skill.

The application distribution server 104 comprises a computer system where such applications can enter the network system. Distribution servers are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

Referring now to Fig. 1a, one exemplary embodiment of a head-end architecture is described. As shown in FIG. 1a, the head-end architecture 150 comprises typical head-end components and services including billing module 152, subscriber management system (SMS) and CPE configuration management module 154, cable-modem termination system (CMTS) and OOB system 156, as well as LAN(s) 158, 160 placing the various components in data communication with one another. It will be appreciated that while a bar or bus LAN topology is illustrated, any number of other arrangements as previously referenced (e.g., ring, star, etc.) may be used. It will also be appreciated that the head-end configuration depicted in Fig. la is high-level, conceptual architecture and that each MSO may have multiple head-ends deployed using custom architectures.

The architecture 150 of FIG. 1a further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 160 as well, although other architectures may be employed (such as for example where the VOD servers are associated with a core switching device such as an 802.3z Gigabit Ethernet device). As previously described, information is carried across multiple channels. Thus, the head-end must be adapted to acquire the information for the carried channels from various sources. Typically, the channels being delivered from the head-end 150 to the CPE 106 (“downstream”) are multiplexed together in the head-end and sent to neighborhood hubs (FIG. 1b) via a variety of interposed network components.

Content (e.g., audio, video, etc.) is provided in each downstream (in-band) channel associated with the relevant service group. To communicate with the head-end or intermediary node (e.g., hub server), the CPE 106 may use the out-of-band (OOB) or DOCSIS channels and associated protocols. The OCAP 1.0, 2.0, 3.0 (and subsequent) specification provides for exemplary networking protocols both downstream and upstream, although the system is in no way limited to these approaches.

It will also be recognized that the multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

As shown in FIG. 1b, the network 101 of FIG. 1 and la comprises a fiber/coax arrangement wherein the output of the MEM 162 of Fig. la is transferred to the optical domain (such as via an optical transceiver 177 at the head-end or further downstream). The optical domain signals are then distributed to a fiber node 178, which further distributes the signals over a distribution network 180 to a plurality of local servicing nodes 182. This provides an effective 1: N expansion of the network at the local service end.

### “switched”Networks

Fig. 1c illustrates an exemplary “switched” network architecture. While a so-called “broadcast switched architecture” or BSA network is illustrated in this exemplary embodiment, it will be recognized that the system is in no way limited to such architectures.

Switching architectures allow improved efficiency of bandwidth use for ordinary digital broadcast programs. Ideally, the subscriber will be unaware of any difference between programs delivered using a switched network and ordinary streaming broadcast delivery.

FIG. 1c shows the implementation details of one exemplary embodiment of this broadcast switched network architecture. Specifically, the head-end 150 contains switched broadcast control and media path functions 190, 192; these element cooperating to control and feed, respectively, downstream or edge switching devices 194 at the hub site which are used to selectively switch broadcast streams to various service groups. A BSA server 196 is also disposed at the hub site, and implements functions related to switching and bandwidth conservation (in conjunction with a management entity 198 disposed at the head-end). An optical transport ring 197 is utilized to distribute the dense wave-division multiplexed (DWDM) optical signals to each hub in an efficient fashion.

Co-owned and co-pending U.S. patent application Ser. No. 09/956,688 filed Sep. 20, 2001 and entitled “TECHNIQUE FOR EFFECTIVELY PROVIDING PROGRAM MATERIAL IN A CABLE TELEVISION SYSTEM”, incorporated herein by reference in its entirety, describes one exemplary broadcast switched digital architecture, although it will be recognized by those of ordinary skill that other approaches and architectures may be substituted.

In addition to “broadcast” content (e.g., video programming), the systems of FIGS. 1a-1c (and FIG. 1d discussed below) can also deliver Internet data services using the Internet protocol (IP), although other protocols and transport mechanisms of the type well known in the digital communication art may be substituted. One exemplary delivery paradigm comprises delivering MPEG-based video content (e.g., “IPTV” or the like), with the video transported to user PCs (or IP-based STBs) over the aforementioned DOCSIS channels comprising MPEG (or other video codec such as H.264 or AVC) over IP over MPEG. That is, the higher layer MPEG-or other encoded content is encapsulated using an IP protocol, which then utilizes an MPEG packetization of the type well known in the art for delivery over the RF channels. In this fashion, a parallel delivery mode to the normal broadcast delivery exists; i.e., delivery of video content both over traditional downstream QAMs to the tuner of the user's STB or other receiver device for viewing on the television, and also as packetized IP data over the DOCSIS QAMs to the user's PC or other IP-enabled device via the user's cable modem.

Referring again to FIG. 1c, the IP packets associated with Internet services are received by edge switch 194, and forwarded to the cable modem termination system (CMTS) 199. The CMTS examines the packets, and forwards packets intended for the local network to the edge switch 194. Other packets are discarded or routed to another component.

The edge switch 194 forwards the packets receive from the CMTS 199 to the QAM modulator, which transmits the packets on one or more physical (QAM-modulated RF) channels to the CPEs. The IP packets are typically transmitted on RF channels that are different that the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve.

It will be appreciated that while the exemplary embodiments presented herein are described in the context of Internet services that include multicast and unicast data (e.g., using an Internet Protocol (IP) networking protocol over one or more transports), other types of services that include multicast transmission of data delivered over a network having multiple physical channels or even virtual or logical channels may be used. For example, switching between various physical channels that comprise a virtual channel, can itself be conducted according to the “switched” approach. As a simple illustration, if a first virtual channel is comprised of physical channels (e.g., QAMs) A, B and D, and a second virtual channel is comprised of QAMs C, E and F, a CM or other CPE can be configured to switch between the A/B/D and C/E/F virtual channels as if they were a single QAM.

### “packetized”Networks

While the foregoing network architectures described herein can (and in fact do) carry packetized content (e.g., IP over MPEG for high-speed data or Internet TV, MPEG2 packet content over QAM for MPTS, etc.), they are often not optimized for such delivery. Hence, in accordance with another embodiment, a “packet optimized” delivery network is used for carriage of the packet content (e.g., IPTV content). FIG. 1d illustrates one exemplary implementation of such a network, in the context of a 3GPP IMS (IP Multimedia Subsystem) network with common control plane and service delivery platform (SDP), as described in co-pending U.S. Provisional Patent Application Ser. No. 61/256,903 filed Oct. 30, 2009 and entitled “METHODS AND APPARATUS FOR PACKETIZED CONTENT DELIVERY OVER A CONTENT DELIVERY NETWORK”, which is now published as U.S. Patent Application Publication No. 2011/0103374 of the same title filed on Apr. 21, 2010, each of which is incorporated herein by reference in its entirety. Such a network provides, inter alia, significant enhancements in terms of common control of different services, implementation and management of content delivery sessions according to unicast or multicast models, etc. ; however, it is appreciated that the various features of the present disclosure are in no way limited to this or any of the other foregoing architectures.

### System Architecture

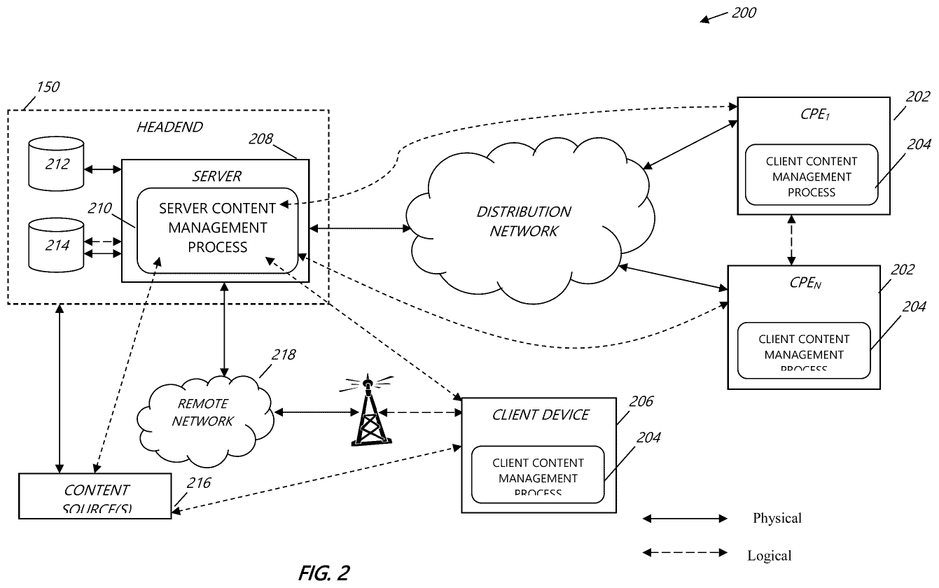

Fig. 2 is a functional block diagram showing an exemplary embodiment of the content distribution system architecture 200 according to the disclosure. It will be appreciated that this generalized architecture may be readily integrated into the existing architecture of a cable television network (such as those shown in FIGS. 1-1d), or alternatively used in conjunction with other types of networks (e.g., satellite networks, DSL networks, optical fiber networks, terrestrial wireless networks, hybrid fiber copper (HFCu) networks, etc.).

As shown in FIG. 2, the exemplary embodiment of the system architecture 200 generally comprises one or more servers 208 (e.g., VOD or broadcast servers) associated with one or more local storage devices 212, one or more network storage devices 214, one or more content sources 216, and one or more CPEs 202 and/or client devices 206.

As shown in FIG. 2, the head-end receives content from a source (such as a web server, studio, etc.) and processes the content into a format compatible with the MSO network. For example, processing may comprise (without limitation): (i) decryption; (ii) authentication of the content source (to prevent, e.g., “spoof” attacks or providing false or surreptitious content); (iii) virus or other mal-ware screening; (iv) encoding, decoding, or transcoding; (v) protocol translation or encapsulation; (vi) “upconversion” or “downconversion” of resolution, and/or (vii) filtration, error correction, or other conditioning of the content. Metadata or other such ancillary data may also be appended to or associated with the ingested content, as described in greater detail subsequently herein.

A client-server software architecture is employed in the exemplary embodiment to provide content management. The software may be employed either wholly or partially on the server-side, such as via a server content management process 210 (SCM). Additionally, the software may be employed either wholly or partially on the client side (e.g., as a client content management process 204 (CCM)). Each of the SCM 210 or CCM 204 may be physically and/or logically integrated into one device or process, or maintained as separate devices/processes even located at disparate locations, as described further below. Alternatively, the function may be implemented in a distributed manner where one or more functional aspects are implemented on multiple platforms.

In one embodiment, an object-oriented distributed application (DA) of the type well known in the art resides on the server portion of the DA, which in the illustrated embodiment can also function as the server content manager (SCM) 210, and is disposed at the head-end 150 of the network (such as on a VOD server or BSA manager 198). The client portion(s) 204 of the DA are disposed at a client device 202 or remote client device 206.

The content source 216 is also in communication with the server content management process 210, so that inter alia the content source can coordinate transfer of purchased or otherwise obtained content (or content prior to purchase) to the MSO network (e.g., local storage 212 and/or virtual storage 214), for supply to the CPE 202. The CPE 202 of the exemplary embodiment can communicate with the server 208 via any number of different channels including, e.g., an OOB upstream channel; in-band upstream channel allocated for this purpose, or a TCP/IP DOCSIS channel.

In one embodiment, the SCM 210 acts as the overall logical control or supervisory process for delivering content to subscribers. In this regard, the SCM 210 acts as somewhat of an overlay onto existing logical and physical processes occurring within the network including, e.g., authentication of subscribers, instantiation of VOD sessions, switching of BSA hubs to deliver content to various subscribers, multicast/unicast IP generation and delivery, etc.

In another embodiment, the CPE 202 communicates with the MSO network via a DOCSIS modem or other such interface, which then relays the communication to an external network (e.g., Internet), which in turn passes the communication to the content source server 218. For example, the user's PC or Wi-Fi connected laptop or tablet at their premises can access the content source website using e.g., the device's browser and TCP/IP protocols, via the indigenous DOCSIS modem, or yet another upstream channel (such as a WiMAX reverse channel, or LTE cellular data interface). In the illustrated example, the CPE 202 and the content source 218 act substantially as peers, and the interposed networks providing physical media and routing functions, although it will be appreciated that other approaches may be used (e.g., such as where processing, reformatting or encapsulation, security wrappers, etc. are applied to the packets issued by the client device by the intermediate networks, routers, and gateways).

After the content source 218 receives the communications (either directly or indirectly) from the CPE 202, it then communicates with the MSO server 208 as previously described. The CPE 202 then subsequently communicates with the server 208, requesting e.g., delivery such as streaming or broadcast of the purchased content. The MSO server portion (or its proxy) then streams or broadcasts the content to the requesting device, or a designated target client device (e.g., one associated with a network or client device on or off the premises, such as a Wi-Fi enabled mobile device).

Content is transmitted to the requesting purchaser's CPE 202 or client device 206, such as via a session between the content server and the CPE 202 (e.g. VOD) that transmits the content over one or more in-band downstream QAMs. Alternatively, delivery may occur via a broadcast (e.g., BSA) mode, an IPTV (e.g., MPEG over IP) mode, unicast/multicast, via satellite link, or any other mode having suitable bandwidth and quality of service (QOS).

Delivery may also occur to remote or visited networks; e.g., to client devices that are outside the MSO or “local” delivery network. Co-owned and co-pending U.S. patent application Ser. No. 11/440,490 filed May 24, 2006 entitled “PERSONAL CONTENT SERVER APPARATUS AND METHODS”, previously incorporated herein by reference in its entirety, discloses exemplary apparatus and methods for delivery of content to remote client devices and networks, although it will be recognized that other apparatus and techniques may be used for this purpose.

In one embodiment, the disclosed system 200 also advantageously provides for upload (such as a substantially automatic upload) of content to a server, storage device, or other network entity from a CPE 202 or other client device 206. This upload functionality of the system may serve as one potential model for preserving copyrights associated with delivered content. Specifically, by downloading the content to a particular user's (or group of user's) CPE, and then uploading the downloaded content in at least a substantially similar form, the receiving user or users has/have become the “owner” of the physical rendering of the content (contrast: copyright in the content) and any rights associated with that rendering (such as rights to perform, reproduce a copy for archival purposes, etc.), and hence what is uploaded back to the network can in fact be considered an “archival” or space-shifted copy of the content they already own. Note that in one implementation of the system 200 of FIG. 2, the content that is received by the CPE or other client 206 is stored on the receiving device in a substantially permanent form (as contrasted with purely ephemeral or transient storage), and then also transmitted upstream to e.g., the network server or storage device for storage thereon, in effect creating two separate versions of the content originally delivered to the CPE. Alternatively, the content received at the CPE/client 206 may simply be ephemerally stored or buffered (e.g., temporarily, while it is processed for upload), and then maintained only at the receiving network-side device, the ephemeral version being deleted. Under the first model, the user can advantageously access the local (CPE) version under most all circumstances, such as when no network connection is active. Likewise, the CPE 202 can act as a local content “server” of sorts for other clients or mobile devices in data communication with the receiving/storing CPE 202. However, the local content consumes significant storage space, and must then be managed with respect to reproduction, distribution, etc. Under the second “cloud based” model, user storage is obviated in favor of e.g., a streaming delivery, but this is obviously subject to network delivery/capabilities, and consumes downstream bandwidth within the network. Combinations or permutations of the foregoing are also envisaged, such as where a “local” copy is only accessible when the network or cloud copy is inaccessible, the network is experiencing downstream bandwidth constraints, a connected client at the CPE premises is requesting the content (and has no direct network access), etc.

In various implementations, the CPE 202 may be configured to automatically upload received content to a designated network storage device. Alternatively, SCM 210 on the server 208 may be configured to automatically initiate a content upload process (e.g., a content “pull”) for content that has been delivered to a CPE 202 or client device 206.

The uploaded content can be subsequently downloaded such as via VOD, unicast/multicast to eligible subscribers, as a binary image or file, or other mechanism. For example, a user can upload content to a server for download/VOD access by others who have authorized access to the content-based network (perhaps other family members or friends), so these other persons can watch the uploaded content on their CPE or other desired platform, while preserving the digital rights associated with such content.

### Network Upload and Storage

In one embodiment, virtual storage devices 214 are maintained for subscribers of the aforementioned networks (or other designated users), thereby giving client devices storage space that they could not otherwise have using their existing equipment. This can be used for any number of different reasons, such as: (i) to archive or back-up data, (ii) to permit access to a data volume by multiple MSO subscribers, (iii) to maintain the security of the data (i.e., when no local copy is present at the subscriber's premises, theft of their computer from the premises is much less troubling), or (iv) to provide the subscriber with storage volume that they could otherwise not obtain. It is also envisioned that the network storage devices 214 within the system can be used as one potential model for preserving the copyright interests of content owners.

The server 208 of FIG. 2 may further comprise or be associated with a storage entity which acts as a network digital video recorder (nDVR) for the CPE 202. In one embodiment, the network DVR may be of the type discussed in co-owned, co-pending U.S. patent application Ser. No. 11/440,490 entitled “PERSONAL CONTENT SERVER APPARATUS AND METHODS” and filed on May 24, 2006, previously incorporated herein by reference in its entirety.

While illustrated generally as a plurality of substantially local components, the architecture of FIG. 2 can have one or more components (such as e.g., storage devices 212 or 214) disposed at a remote location. In one variant, either local storage device 212 or network storage device 214 may be co-located and co-managed by a content source (e.g., studio) or third party. In one variant, requests to access content are processed by the MSO but serviced by content from one or more third party databases (e.g., the databases of studios or other content source can collectively act as the MSO's “virtual library”). Such servicing of content requests can be effectively real-time, with any encoding, annotation, inclusion of metadata, etc. performed essentially on-the-fly (“just in time” processing) if desired.

It may be desirable under certain circumstances (e.g., for certain business models, in order to address security or legal/copyright issues, etc.) to provide the user with some degree of “ownership” or control of the MSO network facilities, whether on a short-term or long-term basis. As such, the user or subscriber may: (i) lease or even own equipment within the network operator's infrastructure or facilities; and/or (ii) extend a virtual control boundary around one or more components or portions of the network operator's equipment or infrastructure.

In one variant, the user or subscriber leases or purchases storage space and/or playback functionality from the MSO. Such lease or purchase may be for a period of time (or number of uses, etc.), or even permanent if desired. To this end, the MSO or other network operator may utilize a highly modular architecture, such that the operations of the leased space/equipment for respective subscribers are largely or completely separated from one another. The MSO maintains the leased/owned equipment (including physical security thereof), and operates the equipment at the behest of the owner. For example, the MSO would determine the configuration of the device, perform software upgrades, periodic maintenance, control encryption/decryption of the stored content, regulate access thereto, etc.

In another variant, a virtual control boundary is further constructed around the subscriber's leased or purchased equipment, thereby allowing them to be in direct control of all aspects of the operation and access of their equipment. For example, one embodiment employs a software application disposed at the client premises (e.g., on their CPE 202) which communicates with a corresponding application or portion at the MSO node (e.g., head-end 150) that controls the operation of the leased/purchased equipment. In this sense, the MSO's equipment is in a very real sense in the possession and under the control of the subscriber, albeit being physically located at a place remote from the subscriber's premises (e.g., the head-end of the cable network). In another variant, these storage and recording/playback apparatus are disposed at a local hub site or other node even more physically proximate to the user's premises.

In another embodiment, the virtual control boundary may be constructed around a group of subscribers or be determined pursuant to determinations made by the server content management process 210. While network storage space is allocated to individual subscribers, other subscribers or the network operator may be able to access, retrieve and/or upload content pursuant to various business models. For example, in response to a request for a content item from a first subscriber, the MSO may access/retrieve that content item stored on the network storage of the second subscriber. This may prove useful in situations where a local copy of the content item is not easily available to the headend or for the purposes of saving storage space when the same or similar content item (i.e., same title, same personalizations, same encoding etc.) exists on the network storage. Alternatively, the MSO may grant access to the first subscriber to access or download content stored on the second subscriber's network storage space. Granted access may be limited to specific content (i.e., the content item that was requested) or limited in duration.

In one variant, subscribers may be grouped according to common characteristics and allowed varying levels of access to other subscribers'network storage space within the same group. For example, subscribers could be grouped according to subscription type, geographic location, node location, or similarities in requested content. Subscribers belonging to the group may access/retrieve content that is stored on the network storage space of other group member's network storage space or network storage space that is specifically allocated for the group.

It will be appreciated that various business models may also be constructed around such “virtual possession” schemes, including for example where the user or subscriber can themselves specify or configure the equipment that they lease or own, much like one currently configures a PC or laptop from a manufacturer at time of purchase. A user can also be provided with the capability of changing or upgrading their equipment, such as for more storage space, different codecs, network interfaces, conditional access, encryption/authentication schemes, indigenous processing or signal conditioning capability, etc.

The network storage device 214 may store content and/or the operating system of the subscriber's CPE 202. In one variant, the CPE 202 operating system may reside entirely off-device, including at the MSO head-end or other such location if desired. Moreover, the data volumes for each subscriber may be encrypted, authenticated, and made physically secure, thereby providing a level of protection that exceeds that of the normal home PC, PMD, or the like.

The virtual storage device 214 can also be made part of a business paradigm; e.g., wherein the user pays a fee (such as on a per-Tb used) or subscribes for X terabytes of storage space for a given period of time.

In one embodiment, the virtual storage device 214 provides storage space for MSO subscribers to upload content to the server 208 or other network entity. The uploaded content can then be accessed, downloaded and/or streamed by a linked subscriber.

In one embodiment, the uploaded content comprises user-generated content. For example, using a cellular phone or tablet camera, microphone, etc., user can stream video up to the VOD server for download/VOD access by others who have authorized access to the content-based network (perhaps other family members or friends), so these other persons can watch the uploaded content on their client device or other desired platform (e.g., PC).

It will also be appreciated that uploaded (e.g., copyright-protected) content may be shared across multiple unrelated “eligible” users of the network. For example, suppose CPEs A, B, and C (each associated with different subscribers at different premises) all download content from the network, such as via respective VOD purchases. Under one implementation, the downloaded content is uploaded by each of the users (e.g., automatically, as described elsewhere herein) to a network storage location. The storage “location” may comprise a common storage area or server (e.g., all three users utilize the same storage), or three (separate) storage areas for each of the users. Hence, any number of logical and/or physical storage partitioning schemes may be utilized consistent with the present disclosure. In one paradigm, all three users in this example maintain separate, independent storage and access thereto. Alternatively, the users may employ a common storage/access approach, such as where each of the users can access a common copy of the content (assuming it is identical). This latter approach economizes on storage requirements in the cloud, since only one copy need be maintained (versus three) in this example. Moreover, upstream bandwidth requirements/latency can in some cases be reduced, since all three copies in the foregoing example need not be uploaded (assuming identical content), but rather only one. Hence, in one variant, the architecture 200 of FIG. 2 is configured such that it includes logic which identifies such commonalities (especially those occurring within a prescribed temporal window), and leverages them to obviate consumption of upstream bandwidth or undue latency for the users. For instance, where the CPE A, B and C of the prior example all request download of content element X within a few minutes of each other, the first downloading device (say, CPE B) initiates its upload first, and the remaining CPE A and C are in effect “waived off” by the network content management process 210 (or other entity) from having to upload their delivered content as well, such as via downstream in-band or OOB message or other signaling.

Likewise, a single cloud-based copy of the content can be logically “interlocked” between two or more users (such as by logic within the management process 210) such that if the content is being accessed by one eligible user, it cannot be accessed by another until the first has completed.

Moreover, where the demand for the content from the network-side storage element will not be immediate, upstream assets can further be optimized through “opportunistic” use of these assets; e.g., a “trickle” and/or “bursty” delivery upstream as time/resources permit. It is also envisaged that different portions of the content may be uploaded from different CPE, so as to in effect cobble together one complete version or copy from multiple sources.

### Network Server and Content Management

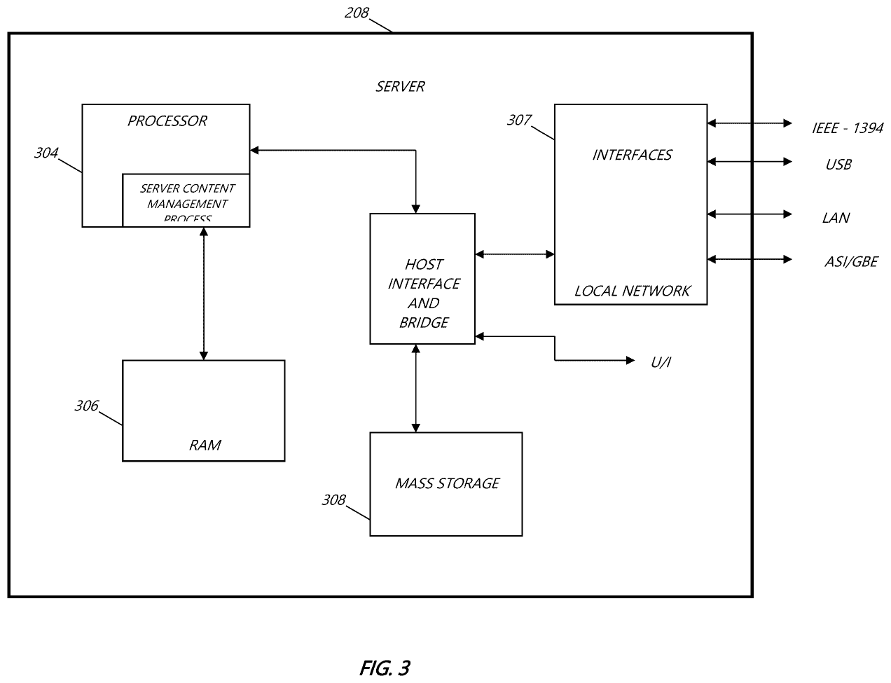

Referring now to FIG. 3, one embodiment of the improved network content server 208 adapted for content delivery and upload according to the disclosure is described. As shown in FIG. 3, the server 208 generally comprises a network server module adapted for interface with the networks of FIG. 2, digital processor(s) 304, RAM 306, a mass storage device 308, and a plurality of interfaces 307 for use with other network apparatus such as LANs, routers, and other packet network devices, network management and provisioning systems, local PCs, etc. Other components which may be utilized within the server include amplifiers, board level electronic components, as well as media processors and other specialized SoC or ASIC devices. Support for various processing layers and protocols (e.g., TCP/IP, 802.3, DHCP, SNMP, H.323/RTP/RTCP, VoIP, SIP, LSCP, etc.) may also be provided as required. Where the content server is also acting in a local network capacity (e.g., as a VOD or application server), an appropriate application is also disposed to run on the server to provide a functional interface for e.g., VOD session requests received from the client device or other interposed entities. These additional components and functionalities are well known to those of ordinary skill in the cable and embedded system fields, and accordingly not described further herein.

As previously discussed, the server 208 also may run the server content management process 210 (SCM). The SCM 210 may be integrated into the server portion of a distributed application process, or alternatively comprise a discrete or stand-alone module having inter-process communication with the server portions (or portions where multiple content servers and server portions are used in conjunction with the SCM 210).

In one variant, the SCM 210 may determine whether the content was previously requested and/or stored on the subscriber's CPE 202 attached to the local (cable) network. This information is gathered by either querying the CPE 202, or by querying a process at the head-end for the program titles stored by or on the CPE 202. In one embodiment, in response to a determination that content has been stored or partially stored on a CPE 202, the SCM 210 may initiate an upload process.

The SCM 210 may also be configured to facilitate reception of uploaded content to the server 208 or other designated host/storage entity. In one variant, uploaded content is received at the network storage device 214 previously described herein. Uploaded content may be stored and organized for example according to metadata associated with the content, or other approach. Metadata information may for instance include description of the content (e.g., title, genre, subject, file type) or details about the data (e.g., size, last updated, source).

In other variants, uploaded content is stored and organized according to predefined rules set by content owners, network operators, users, or a combination thereof. For example, it may be useful for the MSO to index the stored content according to one scheme or rule set (e.g., that minimizes access time, required storage volume, or addresses other parameters), while the user may obtain the best user experience or ease of use through a different organizational scheme. Additionally, content may be stored and organized according to a CPE identifier and/or user identifier that the SCM 210 can cross-reference and use to direct the storage of data. The SCM process 210 may also include options for the configuration of the display and storage of the uploaded content.

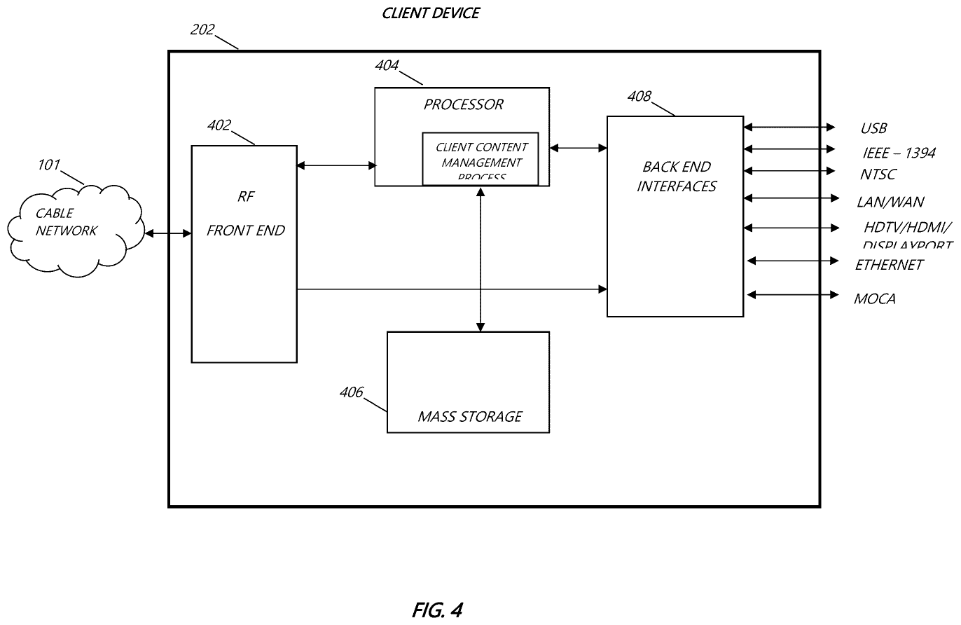

The server device 208 of FIG. 4 may take any number of physical forms, comprising for example one of a plurality of discrete modules or cards within a larger network head-end or edge device of the type well known in the art. The server may also comprise firmware, either alone or in combination with other hardware/software components such as those previously described (e.g., disposed in the aforementioned edge device). Alternatively, the server module 208 may be a stand-alone device disposed at the head end or other location (such as a VOD server 105 or application server 104), and may even include its own RF front end (e.g., modulators, encryptors, etc.) or optical interface so as to interface directly with various portions of the HFC network 101 if desired. Numerous other configurations may be used with any configuration or combination of hardware, firmware, or software, and may be disposed within one or any number of different physical or logical entities.

### CPE Architecture and Operation

Fig. 4 illustrates a first exemplary embodiment of the improved CPE 202 with content selection, download, and upload capability.

In the case of HFC or satellite networks, the CPE 202 in one embodiment comprises a client device in the form of a set-top box with a tuner stage or front end adapted for interface with the relevant physical medium (e.g., connected to the coaxial cable, or a satellite antenna). The CPE 202 may or may not include DVR/PVR functionality. Also, the CPE 202 may not be a physically separate or stand-alone piece of equipment, but be integrated into another device, such as in the case of a cable-ready television set. It will be recognized by those of ordinary skill that myriad different device and software architectures may be used consistent with the content selection, download, and upload functionality, the device of FIG. 4 being merely exemplary.

As shown in FIG. 4, the CPE 202 generally comprises an OpenCable-compliant embedded system (e.g., DSTB) having an RF front end 402 (including tuner and demodulator/decryptors) for interface with the HFC network, digital processor(s) 404, mass storage device 406, and a plurality of interfaces 408 (e.g., video/audio interfaces, IEEE-1394 “Fire Wire”, USB, serial/parallel ports, ThunderBolt, Ethernet, MoCA, etc.) for interface with other end-user apparatus such as televisions, personal electronics, computers, Wi-Fi or other network hubs/routers, etc. Although various protocol are illustrated in FIG. 4, it is appreciated that the CPE 202 of the present disclosure may be configured to communicate over any current and future wireline protocols. Other components which may be utilized within the device (deleted from FIG. 4 for simplicity) various processing layers (e.g., DOCSIS MAC or DAVIC OOB channel, MPEG, etc.) as well as media processors and other specialized SoC or ASIC devices. The CPE 202 may also comprise an integrated HD decoder, thereby relieving any connected monitors or other devices from the requirement of having such a decoder. These additional components and functionality are well known to those of ordinary skill in the cable and embedded system fields, and accordingly not described further herein.

The CPE 202 of FIG. 4 is also provided with an OCAP-compliant application and Java-based middleware which, inter alia, manages the operation of the device and applications running thereon. Different device and software architectures may be used consistent with the tuning and channel request functions, for example, different middlewares (e.g., MHP, ARIB, or ACAP) may be used in place of the OCAP middleware of the illustrated embodiment.

As part of the application layer of the CPE 202 protocol stack (not shown), various different types of client applications may be operational. In one embodiment, a separate (dedicated) client application adapted for content selection, browsing, download, and upload may be used to interface with the lower layers of the stack. This may include, e.g., a separate GUI or other type of UI, and may operate substantially independent of other applications on the CPE 106. Alternatively, the selection, download, and upload functionality described herein may be integrated into one or more existing or downloadable applications (such as a VOD application, “Watch TV” application, navigator, TV-commerce application, or even EPG). The application (and even session) layer protocols necessary to control the content selection, download, and upload functionality may even be disposed on another device (e.g., PDA or cellular smartphone) as previously described in order to instigate the browsing, selection, purchase, download/streaming, and upload of content.

In another embodiment, the client application can function in response to signals or communications provided by a device in communication with the CPE 202. For example, the CPE 202 may comprise a wireless interface (e.g., 802.11 a/b/g/n, Bluetooth, 802.15 PAN, 802.16 WiMAX, 802.20, etc.) such that it can service content selection, payment, download/streaming, and upload requests from client devices of the CPE 202 itself. In one such variant, the client device comprises a tablet, smartphone, PDA, gaming console, or similar handheld device that has a distributed portion of the client application running thereon. This application may be stand-alone or integrated with another application. Hence, users operating the distributed client application on the tablet/smartphone/PDA will utilize their wireless interface to the CPE 202 in order to remotely instigate a content download or upload from the network via the CPE, the latter in effect acting as a gateway to the content distribution network. The wireless forward channel(s) of the interface (e.g., CPE to PDA) can be used to transmit the content after processing (e.g., decoding) by the CPE, or even stream the “raw” unprocessed content (or even the received and demultiplexed MPEG encoded packets) to other client devices and/or network storage.

The exemplary client device 202 further comprises a personal content or media application, which allows a user to manage his/her personal content. Such management includes, but is not limited to, the ability to browse through content stored to see which are available for viewing, select content for local viewing, and configure various parameters associated with the upload of content. As previously described, the content available for viewing may be stored locally, or alternatively may be stored remotely, such as at the head-end, BSA hub, or even a third party content source.

The personal content application is also responsive to a network-side application (e.g., server portion of a DA) that queries the client device 202 to check on the content titles stored on the client device 202 (when a local storage model is used), and upload data related thereto.

In one implementation, the client program resident on the CPE 202 tracks and reports user activity related to personal content viewing to the relevant server(s) for each client device. This activity tracking is useful from a number of perspectives, including: (i) determining when content is stored or uploaded to a network storage device; (ii) determining when programs are added or deleted from the local storage (e.g., subscriber's DVR); and (iii) for billing purposes. This tracking can also be performed in a substantially anonymous fashion, such as through use of cryptographic hashes of TUNER ID, MAC, and similar variables as described in co-owned, co-pending U.S. patent application Ser. No. 11/186,452 filed on Jul. 20, 2005 and entitled “METHOD AND APPARATUS FOR BOUNDARY-BASED NETWORK OPERATION”, which is incorporated herein by reference in its entirety. Such mechanisms allow for specific identification of the CPE 202 which has recorded or accessed content, without necessarily having to know the subscriber's identity.

Furthermore, an application on the CPE 202 can be made to be responsive to the user's commands to control the DVR from the remote or visited network. Such a logical connection from the remote network to the LCD can be implemented using any number of different approaches, including direct communications between the CPE 202 and the remote client device 206 (e.g., via Internet), relayed communications that pass through the MSO (local) infrastructure and so forth. Allowing the subscriber to set up such a connection provides a remote management interface to managing the CPE 202 to perform personal media related functions, among others, thereby adding significant flexibility to the operation and utilization of the remote content access functionality.

As previously discussed, content can be uploaded to the MSO or third party network storage device, and subsequently downloaded/streamed and viewed at the subscriber's premises (or those of other subscribers authorized to view the content). Such download may also be to a second appropriately equipped remote client device 206. Content may be uploaded on an upstream channel of the cable network, or through another network such as through a cell network (e.g., LTE/LTE-A) or 802.16 wireless, or via a broadband Internet connection (such as e.g., optical fiber, wireless, or other mechanism.

In one embodiment, the upload functionality may be automatic or otherwise completely transparent to the end user, such as where an application running on the CPE 202 (or an associated device) (i) initiates a session if not already established, (ii) uploads the data, including any necessary error correction and/or retransmission, and (iii) manages termination of the session. The upload may comprise any form of transmission, such as binary image, streamed, one or more files, etc.

### Individualized Content Channel Variants

In one aspect, the foregoing techniques of local receipt (and optional storage) and upload back to the network or other entity may be combined with personalized virtual or other content channel approaches to, inter alia, leverage data relating to user behavior on a per-user basis. See for example co-owned and co-pending U.S. patent application Ser. No. 12/414,554 filed Mar. 30, 2009 entitled “PERSONAL MEDIA CHANNEL APPARATUS AND METHODS” which is incorporated herein by reference in its entirety, which discloses among other things, methods and apparatus for “fused” targeted content delivery in a content-based network. Specifically, a substantially user-friendly mechanism for viewing content compiled from various sources is provided, including, inter alia, DVR, broadcast, VOD, Start Over, etc. Content selected to align with a user's preferences is displayed as a substantially continuous stream as part of a “virtual” user-based channel. In one embodiment, a user profile is constructed and targeted content gathered without requiring any user intervention whatsoever; e.g., based on a user's past or contemporaneous interactions with respect to particular types of content. This information can be generated by, for example, a recommendation “engine” such as that described in co-owned and co-pending U.S. patent application Ser. No. 12/414,576 filed Mar. 30, 2009 entitled “RECOMMENDATION ENGINE APPARATUS AND METHODS” which is also incorporated herein by reference in its entirety. The “virtual channel” acts as a centralized interface for the user and their content selections and preferences, as if the content relevant to a given user were in fact streamed over one program channel. The compiled content may also presented to the user in the form of a “playlist” from which a user may select desired content for viewing and/or recording. The user is able to navigate between on-demand content, the virtual channel, an EPG, a search tool, and a DVR navigation tool from a single user interface (e.g., on-screen display).

In another aspect, client applications (e.g., those disposed on a subscriber's CPE and/or network servers) are utilized to compile the playlist based on user-imputed as well as pre-programmed user profiles. Various feedback mechanisms may also be utilized to enable the client application to “learn” from the user's activities in order to update the user profile and generate more finely-tuned and cogent recommendations. Client applications may also be utilized to manage the seamless presentation of content on the virtual channel, and locate/flag various scenes inside selected content for user viewing or editing.

Hence, in one variant, logic is included within the CPE and/or network content management entity (e.g., SCM 210) such that the items which are selected to populate the user's virtual channel are selectively downloaded (and then uploaded back to the network for storage), so as to populate the storage entity of the network associated with that user with content that has been particularly selected for that user/premises. When a user selects something outside of the recommended content, the logic is configured in one embodiment to cause download and upload of that content onto the storage entity, so as to update the storage on a rolling basis.

### Method of Uploading

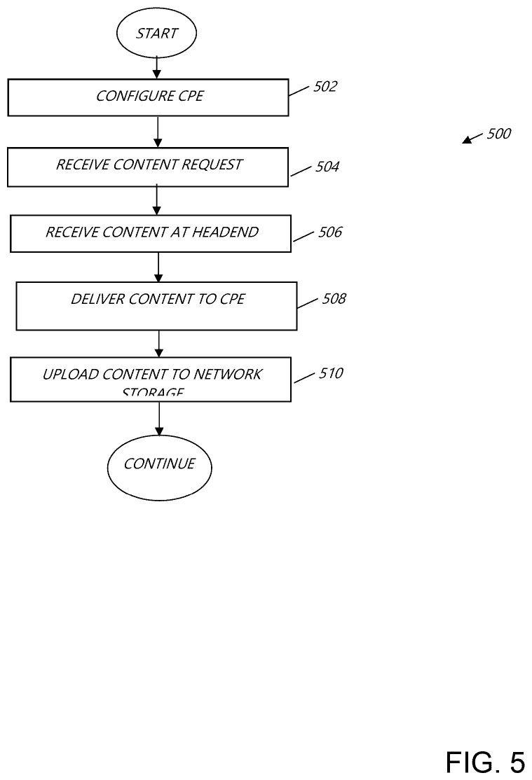

Fig. 5 shows one exemplary embodiment of the generalized method of delivering, uploading, and storing content over a network as described. It will be appreciated that while the following embodiment is described primarily in terms of an on-demand (OD) “session” based model delivering content over an in-band channel, the system is equally adapted to non-OD models such as broadcast/multicast (described in detail subsequently herein), data/content download via a cable modem (e.g., IP transport modality), out-of-band (OOB) communications channel, etc., the VOD exemplar being merely illustrative of the broader principles of the disclosure.

In a first step 502 of the method 500, a CPE 202 is configured. In one embodiment, the server content management process 210 configures the CPE 202 to operate in a determined fashion. Alternatively, the client content management process 204 configures the CPE 202 to operate in a determined fashion. In one variant, the CPE 202 is configured to designate a server 208 and/or network storage device 214 for the reception of uploaded content. The CPE may also merely upload the content “blindly” to a designated network address (e.g., cache or buffer), which is then processed by a head-end or other entity in order to properly record the content in a fashion accessible by the user.

In another variant, the CPE 202 may be configured to automatically upload content at a predetermined time. In yet another variant, the CPE 202 may be configured to automatically upload content upon the occurrence of an event (e.g., expiration of a timer, receipt of a message from the network, sufficient bandwidth availability, etc.). In still yet another variant, the CPE 202 may be configured to automatically upload in response to a user upload command. Various techniques for the configuration of the CPE 202 will be discussed further herein.

In step 504 of the method 500, the desired content is made available, and purchased or requested by a user (e.g., MSO subscriber). The request for the content may be instigated from the CPE 202 or a client device 206, or may be as a result of interaction with a third party (e.g., content source) web server, operator or other such network agent.

In one embodiment, a user is provided with a listing of available content, comprising e.g., one or more entries corresponding to different content titles, encoding formats, features, purchase options, and so forth, via a user interface. For example, one variant utilizes an on-screen display or GUI, generally similar to the well-known electronic programming guide (EPG), that lists the various choices available for purchase. These might be indexed by category (e.g., feature length movie, gaming application, video “shorts”, music, etc.), and sub-indexed by genre (e.g., comedy, drama, etc.), alphabetically by title or primary actors, etc. Alternatively, a user might simply be presented with a short GUI menu or pop-up display mechanism (e.g., window) listing new releases for that week or month. The user interface can be invoked in response to a user request, such as for example by selecting a button on the user's remote that interacts with their CPE 202, at a pre-designated periodicity (e.g., once per week), upon the occurrence of a particular event (e.g., new release), or at the instigation of the MSO, although myriad other approaches will be recognized by those of ordinary skill.

It will be appreciated that such user interface is not limited to the MSO network domain either. For example, as described in greater detail subsequently herein, the user interface may comprise part of a PMD or mobile device (e.g., PDA or smartphone), which can access the MSO virtual database manager from a remote location or network.

Once the user makes their selection(s), this information is transferred to the server content management process 210 via an upstream communication channel, DOCSIS modem, ISP connection, or other modality appropriate to the user's situation. The user's selection (e.g., availability) and payment information are then validated, such as by accessing a subscriber database associated with that user (as determined by, e.g., TUNER ID, MAC, or other information uniquely identifying the requesting CPE/subscriber.

Menus or other user interfaces may also be generated for receiving user preferences (e.g., format, particular versions of the same content, codec selection, upload configuration etc.). This information can be transmitted to the head-end at time of selection, or alternatively pre-stored in a configuration file disposed in the head-end or other location directly accessible to SCM 210).

Next, per step 506, the purchased/requested content is delivered to a storage facility at the headend 150 (if not already there), such as a local storage device 212 shown in FIG. 2. In one embodiment, the user's content selections and preferences, which may be received either at time of purchase or pre-stored, are received by the SCM 210.

Selected content is optionally encoded or recoded as required (e.g., such as where the content requires encoding into the format requested by the user). The content can alternatively be coded “on the fly”, such as immediately preceding streaming over a VOD session.

Note that storage need not necessarily occur at this stage of the method 500 (or at all); rather, in another variant the SCM 210 merely identifies and validates the subscriber and permits access to content that has already been stored or that is available for streaming.

In one embodiment, the system provides a storage optimization algorithm rendered as a computer program running within the architecture (i.e., either at the head-end, the client device, or as a distributed application as described elsewhere). The optimization algorithm may be structured to store content in a more space-efficient and operationally efficient manner. In one variant, the storage optimization determines whether a content item has already been uploaded/stored to the head-end. If the content item has already been uploaded once, the content optimization algorithm may prevent or delete duplicate copies from being stored or uploaded at the head-end. The algorithm may operate with respect to the network storage space associated with an individual user, or alternatively to the network storage space of multiple users or even the local storage of the head-end or network storage as a whole. To that end, the MSO head-end saves space by building a database or library of content that has been uploaded in network storage space by subscribers and using that database as a source for future requests of content. If there is a request for a content item that has been already uploaded but requires different personalizations or encodings, the SCM 210 may access the content item stored in the network storage device 214 and apply the differences before delivering the content item to the requesting device. The requesting device may or may not be required to be grouped or linked with the subscriber account associated with the uploaded content.

In step 508, the content is delivered to the target device (e.g., customer CPE 202 or client device 206) via a communication channel. The content is transmitted to the requesting CPE or client device, such as via a session between the content server and the CPE (e.g. VOD) that transmits the content over one or more in-band downstream QAMs. Alternatively, delivery may occur via a broadcast (e.g., BSA) mode, an IPTV (e.g., MPEG over IP) mode, via satellite link, or any other mode having suitable bandwidth and quality of service (QOS).

Delivery may also occur to remote or visited networks; e.g., to client devices that are outside the MSO or “local” delivery network. Co-owned and co-pending U.S. patent application Ser. No. 11/440,490 filed May 24, 2006 entitled “PERSONAL CONTENT SERVER APPARATUS AND METHODS”, previously incorporated herein by reference in its entirety, discloses exemplary apparatus and methods for delivery of content to remote client devices and networks, although it will be recognized that other apparatus and techniques may be used for this purpose. Accordingly, it will be appreciated that the methodology of FIG. 5 advantageously is substantially agnostic to the bearer medium, and amenable to redirection (i.e., requesting, customizing, receiving, and uploading the content can all be conducted at different locations or using different platforms).

In other variants, a user session based on the Session Initiation Protocol (SIP) is used for delivery, whether with the same or another bearer medium such as a non-VOD approach, or a WAP Wireless Session Protocol (WSP) session disposed on a handheld device, and so forth. It is noted that in such SIP or WAP variants, the initiating device need not necessarily be the target device (e.g., DSTB) to which the content is streamed. Rather, the SIP or WAP-enabled device can act as a session proxy for the DSTB or other target CPE, such as where the user utilizes their SIP-enabled PDA to communicate with a head-end or other content-providing network entity to establish the download session.

The aforementioned VOD or other session (or user-specific broadcast in the BSA variant) may be initiated promptly, e.g., automatically upon authorization of the transaction, or alternatively at another time selected by either the MSO or the user (such as, e.g., at a pre-determined day or date when the content is to be released). Similarly, if the target CPE (e.g., DSTB) has multiple RF tuners and one is available, data/content streaming or download can be initiated immediately, or as soon as a tuner becomes available when all are initially in use. Likewise, if the CPE has a single tuner, the data/content streaming or download is initiated when that single tuner is free.

The foregoing transmission or delivery logic can also be masked with other requirements if desired, such as where both a free tuner and the permitted viewing start time falling within a prescribed temporal window are required (i.e., viewing or access is valid only for a certain “aging” period), or where the user acknowledges a splash screen or comparable mechanism acknowledging the copyright of the content to be viewed (akin to a physical DVD, where the user's DVD player controls are ineffective during the copyright notice portions), and the restrictions on its use. Masking may also be based on network status or bandwidth availability, such as where the session will not be instantiated until sufficient bandwidth is available to provide a sufficiently high assurance of completing the streaming or download (and/or upload).

Upon receipt, the target device either conducts playback of the content, such as the playing of an MPEG-2 stream, or alternatively the playback of a compressed video file downloaded at high speed, or even the installation and execution of an application. In response to the receipt of content, a notification may be sent upstream that includes recording information about the content item.

It will be appreciated that the delivery of the content may occur immediately, e.g., immediately after or even contemporaneous with storage (if used) or buffering, and/or may occur at a subsequent time or date, depending on the purchaser's preferences.

In step 510, the CPE 202 or client device 206 uploads the received content to a designated network host. The designated network host may be a server 208 in the headend 150, or network storage space not located and/or directly associated with the MSO server. In one variant, the server 208 receives the uploaded content and redirects the content to its associated network storage space 214. Content may be uploaded on an upstream channel of the cable network or through a remote network as previously described. In one variant, content may be uploaded by transferring the content to a connected user device and using the connected user device to upload the content. For example, a CPE 202 may, in response to a user request, transfer content (e.g., via a premises network connection, USB connection, etc.) to a client device which is configured to upload the content contemporaneously with or as an alternative to the upload function of the CPE 202. The request may come from a user of the CPE 202 or a remote client device. In one variant, only a portion of the whole program content is transferred the connected user device.

In one variant, the content is transferred to a second premises device and uploaded to the network storage from there, in response to a determination that insufficient upload bandwidth or tuner availability at a first premises device will frustrate upload of content to the head-end. For instance, the received content may be transferred via wired or wireless interface to the upload session will not be instantiated until sufficient bandwidth is available to provide a sufficiently high assurance of completing the upload. Alternatively, content is transferred upon determination that another premises device will upload data more efficiently.

In one embodiment, the system provides an upload prioritization algorithm rendered as a computer program running within the architecture (i.e., either at the head-end, the client device, or as a distributed application as described elsewhere). The upload prioritization algorithm contains an upload queue and may schedule and/or rank multiple upload events. In one variant, content items may be cross referenced with a database stored within the system 200 or contain metadata that indicates the importance that a particular item is uploaded. The upload prioritization algorithm interprets the upload priority information and schedules upload events accordingly. For example, Content Item A has an upload priority of 10, Content Item B has an upload priority of 5, and Content Item C has an upload priority of 1. Upon receiving and interpreting this data, the upload prioritization algorithm schedules Content Item A for immediate upload, Content Item B for upload next week, and Content Item C for upload not necessary or only upon user request. As such, the system is able to adapt to varying requirements for digital rights as set by content owners or the MSO while preserving upload bandwidth for items where upload may not be necessary.

In another embodiment, the CPE 202 is configured to upload content periodically. After a predetermined period of time, the CPE 202 determines if any new or updated content has been stored and uploads the new or updated content. Content may be considered new or updated if all or a portion of the files associated with the stored content have changed since the last upload occurred. The CPE 202 may maintain a list or database of content items that have been stored or are scheduled to be stored. In one variant, the database includes information about the stop and start times of download, upload and record events. Alternatively, the CPE 202 may indicate changes to content and the start and stop times of download, upload, and record events in the metadata associated with the content. As an illustrated example, a CPE 202 may be configured to upload content every Monday at 12:00 PM. The CPE 202 scans its records for new content on Monday at 12:00 PM, finds content item A was stored the previous Saturday, adds item A to an automatic upload queue and indicates the appropriate changes in a database and/or metadata.

In one embodiment, the CPE 202 is configured to automatically upload content upon reception of the content. In one variant, the CPE 202 is configured to automatically upload content once it has been received and/or after a predetermined time occurs/lapses after reception. Content may be considered received when reception of the content begins, when storage of the content has been completed, or at a time in between those two stages (i.e., a predetermined percentage of content has been downloaded and stored). In one variant, the CPE 202 parses the content in a memory buffer so that portions of the content may be uploaded to the network before the entirety of the content item has been received at the CPE 202.

In one embodiment, a flag or marker may be stored and/or transmitted by the client content management process 204 on the CPE 202 to indicate reception of content. The flag may identify a content item to an internal or external process as new content that has been received. Alternatively, the flag may indicate that a search or query should be performed by an internal or external process to identify new content on the CPE 202. The head-end or CPE may initiate an upload in response to receiving the flag.

In one embodiment, the CPE 202 is configured to automatically upload content in response to an event. In one instance, content upload is performed after a predetermined number of content items have been received at the CPE 202. Alternatively, content upload is performed when the server 208 has delivered a predetermined number of content items. In another variant, content upload my performed when storage space on the CPE 202 hard drive has exceeded a predetermined capacity.

In one embodiment, the determination of new content is performed by the server content management process 210 at the headend. When content is delivered to the subscriber, the SCM 210 updates a database that tracks the reception of content by the CPE 202. The database may be stored at the CPE 202, the headend 150, or network storage devices located offsite. In response to a lapsed period of time, event, or request, the SCM 210 accesses the database to determine if the CPE 202 has received content that has not yet been uploaded and if so, sends a command to the CPE 202 to initiate an upload of the new content. Alternatively, the server content management process 210 may query files stored on the CPE 202 to determine if new content exists.

In one embodiment, individual storage space is allocated for each CPE 202. The allocated storage space may be expanded or reduced based on various business considerations and/or the subscription agreement between the operator and user. Content that is uploaded is stored at the head-end or network storage device 214 and then made available for subsequent access. Additionally, the content may be encrypted before being uploaded to the head-end.

In one embodiment, when a plurality of users have requested, downloaded or uploaded the same content item(s), the storage optimization algorithm discussed above may store fewer or a single instance of the content item at the network storage device to prevent or reduce multiple copies of the same content item. The storage optimization algorithm may dynamically adjust the number of content item(s) stored in the network according to the popularity of the item or according to a time that has been determined to be a time of high demand for at item or similar content items.

In another embodiment, the storage optimization algorithm determines whether a content item has already been uploaded by that user. If not, an upload is scheduled for content that has not yet been uploaded. If the content has already been uploaded, the storage optimization algorithm may remove the content from the local storage of the CPE 202 since the subscriber will be able to access and receive the content at a subsequent time from the network storage. In one variant, the SCM 210 or CCM 204 prompts the user with options for deleting local content that has already been uploaded. In another variant, a pre-stored configuration file stored on the CPE 220 or at the head-end is used to determine rules for removing duplicate copies of content. For example, the CPE 202 may be configured to prompt the user for duplicate removal only when the capacity of the CPE 202 hard disk space has exceeded a predetermined threshold. In yet another variant, removal or prompting for removal only occurs after a determination that both the content has already been uploaded and the content has been viewed at least once by the user.

An upload may be cancelled if the recording or storage of the content at the CPE 202 is interrupted or fails to complete. In one variant, the CPE 202 may automatically send a notification upstream to the head-end if the content item is not completely received. Alternatively, the head-end may determine that a recording is incomplete when it compares metadata (e.g., start/stop times of the recording, size, etc.) with data values known to be consistent with a complete recording of that particular content item.

It will be recognized that while certain aspects herein are described in terms of a specific sequence of steps of a method, these descriptions are only illustrative of a broader method and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the system disclosed and claimed herein.

While the above detailed description has shown, described, and pointed out novel features as applied to various embodiments, it will be understood that various omissions, substitutions, and changes in the form and details of the device or process illustrated may be made by those skilled in the art. This description is in no way meant to be limiting, but rather should be taken as illustrative of the general principles. The scope should be determined with reference to the claims.

1.-22. (canceled)

23. A computerized network apparatus configured to obtain and store digital content from one or more computerized client devices, the computerized network apparatus comprising:
a digital processor apparatus; and
a storage apparatus in data communication with the digital processor apparatus and comprising at least one computer program thereon, the at least one computer program comprising a plurality of instructions which are configured to, when executed by the digital processor apparatus, cause the computerized network apparatus to:
determine that at least a portion of the digital content has previously been stored at a cloud-based storage location associated with and restricted to access by a user of the one or more computerized client devices; and
based at least in part on the determination, provide the one or more computerized client devices access to the digital content.

24. The computerized network apparatus of claim 23, wherein the plurality of instructions are further configured to, when executed by the digital processor apparatus, cause the computerized network apparatus to:
based on the determination, cause removal of a copy of the digital content stored at the one or more computerized client devices.

25. The computerized network apparatus of claim 24, wherein the plurality of instructions are further configured to, when executed by the digital processor apparatus, cause the computerized network apparatus to:
transmit notification data to the one or more computerized client devices, the notification data configured to display one or more options for removal of at least one of: (i) removal of the copy of the digital content stored at the one or more computerized client devices, or (ii) removal of the digital content from the cloud-based storage location.

26. The computerized network apparatus of claim 23, wherein:
the one or more computerized client devices comprise a first computerized client device and a second computerized client device; and
the cloud-based storage location is interlocked between the first computerized client device and the second computerized client device, such that the digital content cannot be accessed by one of the first or second computerized client devices until an other one of the first or second computerized client devices has completed the access of the digital content.

27. The computerized network apparatus of claim 23, wherein the plurality of instructions are further configured to, when executed by the digital processor apparatus, cause the computerized network apparatus to:
transfer the digital content from the cloud-based storage location to a second cloud-based storage location, the transfer based on storage space at the cloud-based storage location falling below a predetermined capacity.

28. The computerized network apparatus of claim 23, wherein the plurality of instructions are further configured to, when executed by the digital processor apparatus, cause the computerized network apparatus to:
cause storage of the digital content at the cloud-based storage location;
based on the storage of the digital content at the cloud-based storage location, cause removal of the digital content from local storage at the one or more computerized client devices; and
the storage of the digital content at the cloud-based storage location and the removal of the digital content from the local storage based on storage space at the local storage exceeding a predetermined capacity.

29. The computerized network apparatus of claim 23, wherein the plurality of instructions are further configured to, when executed by the digital processor apparatus, cause the computerized network apparatus to:
based at least in part on the determination, utilize the at least portion of the digital content previously stored at the cloud-based storage location and another portion of the digital content stored at a second cloud-based storage location to enable the digital content to be rendered in totality by the one or more computerized client devices.

30. The computerized network apparatus of claim 23, wherein:
the plurality of instructions are further configured to, when executed by the digital processor apparatus, cause the computerized network apparatus to:
collect data from a plurality of content sources, the collected data relating at least to prior activity by the one or more computerized client devices; and
the determination that the at least portion of the digital content has previously been stored at the cloud-based storage location comprises utilization of the data relating to the prior activity by the one or more computerized client devices.

31. Computer readable apparatus comprising a non-transitory storage medium, the non-transitory storage medium comprising at least one computer program having a plurality of instructions, the plurality of instructions configured to, when executed on a processing apparatus, cause a computerized apparatus to:
cause storage of digitally rendered content at a first storage location associated with a first computerized client device; and
automatically store the digitally rendered content at a second storage location of a cloud-based storage apparatus associated with the first computerized client device;
wherein the automatic storage at the second storage location is based at least on a determination that the digitally rendered content has been stored at the first storage location.

32. The computer readable apparatus of claim 31, wherein:
the plurality of instructions are further configured to, when executed by the processing apparatus, cause the computerized apparatus to:
collect data from a plurality of content sources, the collected data relating at least to prior activity by the first computerized client device; and
the determination that the digitally rendered content has previously been stored at the first storage location comprises utilization of the data relating to the prior activity by the first computerized client device.

33. The computer readable apparatus of claim 31, wherein:
the second storage location is further associated with a second computerized client device; and
the digitally rendered content is accessible from the second storage location to only one of the first computerized client device or the second computerized client device at a then-current time.

34. The computer readable apparatus of claim 31, wherein the plurality of instructions are further configured to, when executed on the processing apparatus, cause the computerized apparatus to:
evaluate at least portions of the digitally rendered content with respect to one or more criteria; and
determine an upload classification of the digitally rendered content based at least on the evaluation.

35. The computer readable apparatus of claim 34, wherein the determination of the upload classification comprises utilization of at least a determination of a performance within a prescribed temporal limit to classify the digitally rendered content as either requiring upload to the second storage location or not.

36. The computer readable apparatus of claim 34, wherein:
the determination of the upload classification comprises:
identification of metadata stored in association with the digitally rendered content, the metadata comprising data related at least to one or more respective stop and start times of the digitally rendered content; and
assignment of a metric to the digitally rendered content, the metric relating to a relative priority classification based at least on the identified metadata; and
the causation of the storage at the first storage location is based at least on the relative priority classification.

37. The computer readable apparatus of claim 36, wherein the plurality of instructions are further configured to, when executed on the processing apparatus, cause the computerized apparatus to:
access of a database to identify the data related to the one or more respective stop and start times, the data related to the one or more respective stop and start times tracked via client application computer programs each configured to run on respective ones of the first and second computerized client devices.

38. A computerized method of managing digitally rendered content within a content delivery network configured for data communication with one or more computerized client devices, the computerized method comprising:
causing storage of the digitally rendered content at a first storage location associated with the one or more computerized client devices, the first storage location associated with and restricted to access by at least one user of the one or more computerized client devices;
automatically storing the digitally rendered content at a second storage location of a cloud-based storage apparatus associated with the one or more computerized client devices;
determining that at least a portion of the digitally rendered content has been previously stored at the storage location; and
based at least in part on the determining, providing the one or more computerized client devices access to the digitally rendered content.

39. The computerized method of claim 38, wherein:
the one or more computerized client devices comprises a first computerized client device; and
the causing of the storage of the digitally rendered content at the first storage location associated with the one or more computerized client devices comprises causing storage of the digitally rendered content at a first storage location of the cloud-based storage apparatus, the first storage location specifically associated with the first computerized client device.

40. The computerized method of claim 39, wherein:
the one or more computerized client devices comprises a second computerized client device;
the automatically storing of the digitally rendered content at the second storage location of the cloud-based storage apparatus associated with the one or more computerized client devices comprises automatically storing of the digitally rendered content at the second storage location of the cloud-based storage apparatus, the second storage location specifically associated with the second computerized client device; and
the digitally rendered content is accessible only to only one of the first computerized client device or the second computerized client device at a then-current time.

41. The computerized method of claim 38, wherein:
the causing of the storage of the digitally rendered content at the first storage location associated with the one or more computerized client devices comprises causing storage of the digitally rendered content at a first local storage location of a first computerized client device; and
the automatically storing of the digitally rendered content at the second storage location of the cloud-based storage apparatus associated with the one or more computerized client devices comprises automatically storing of the digitally rendered content at the second storage location of the cloud-based storage apparatus associated with the first computerized client device based on one or more operational metrics associated with at least one of: (i) a network associated with the first computerized client device, or (ii) the first computerized client device.

42. The computerized method of claim 41, wherein the automatically storing of the digitally rendered content at the second storage location comprises a transfer of the digitally rendered content from the first local storage location to the second storage location of the cloud-based storage apparatus based on storage space at the first local storage location falling below a predetermined capacity.
